(19) United States
(12) Patent Application Publication
(10) Pub. No.: US 2006/0164929 A1
(43) Pub. Date: Jul. 27, 2006

(54) Dual compact disc player

(76) Inventor: Earl Germon Marshall, Jacksonville, AR (US)

Correspondence Address: EARL G. MARSHALL, 5653 AR. HWY. 294, JACKSONVILLE, AR, 72076, US

(21) Appl. No.: 11/041,817

(22) Filed: Jan. 25, 2005

(51) Int. Cl. G11B 5/09

(52) U.S. Cl. 369/30.01; 369/47.1

(57) ABSTRACT

This invention concerns a portable compact disc player that is cable of playing two CDs one at a time upon request. This invention uses an extra laser eye and laser discs holder to enable the portable disc player to read two different CDs. The disc player opens in a normal fashion exposing the first laser eye and CD holder. The first compact disc is inserted into player in a traditional manner. The second compact disc is then inserted on top of the first disc with information to read facing upward. To listen to the first disc, the user will press down the number two hold button. The additional laser eye inside the roof of the player will be disabled allowing only the first laser eye to read disc number one. To listen to disc number two the user would press down the number one hold button which would disable the first compact disc and read the second compact disc.

### BACKGROUND OF INVENTION

The present invention concerns a new improved portable disc player that is able to play two different discs, one at a time upon request. There have been various portable compact disc players that have improved the standard disc player and patented in the U.S.A. before, but none of them are believed to anticipate the functions of my new dual disc structure. A variety of portable compact disc players have been the subject of earlier U.S. patents. In my field of research of U.S. patent documents, I found no portable compact disc player that was similar to my invention in design or function. My invention is an improvement to the standard portable compact disc player in utility function and design.

### BRIEF SUMMARY OF THE INVENTION

Objects and advantages of the invention are set forth in part in the following description, or may be obvious from the description

According to important features of my invention, the use of an extra laser eye disc reader to read an additional compact disc is original in its utility. One important feature of my new portable compact disc player involves a new concept button called the hold button. The hold button allows the user to choose which disc he or she would like to listen to.

According to other important feature of my invention, the use of a slightly longer CD holder that allows the portable disc player to hold two CDs, and the use of another control feature attached to the head headphones enabling the use of the hold button is original in its utility.

Important feature of dual disc configuration is being MP3 compatible, allowing triple the normal of information in portable disc player.

According to my present invention, I have provided a portable compact disc player that is unique in design and utility. The use of an extra laser eye, longer disc holder, and the hold button concept enables my invention to play two compact disc individually upon request.

Another feature of my invention concerns the use of a control device located on the cord of the headphones. The control device has all the major functions of the portable compact structure. This device will enable the user to command the play, pause, skip forward, skip backward, and hold buttons.

### DESCRIPTION OF THE DRAWINGS

FIG. 1: is the unopened form of the dual disc player. It shows the disc player from the top view. In unopened form it looks like a traditional compact disc player with the usual display screen and various button configurations.

FIG. 2: shows the dual disc player in its opened state. When open, the dual disc unveils what looks like the normal insides of a portable disc player. At the base of the dual disc is the first laser eye and longer disc holder. The opened roof portion of the dual shows the second laser eye.

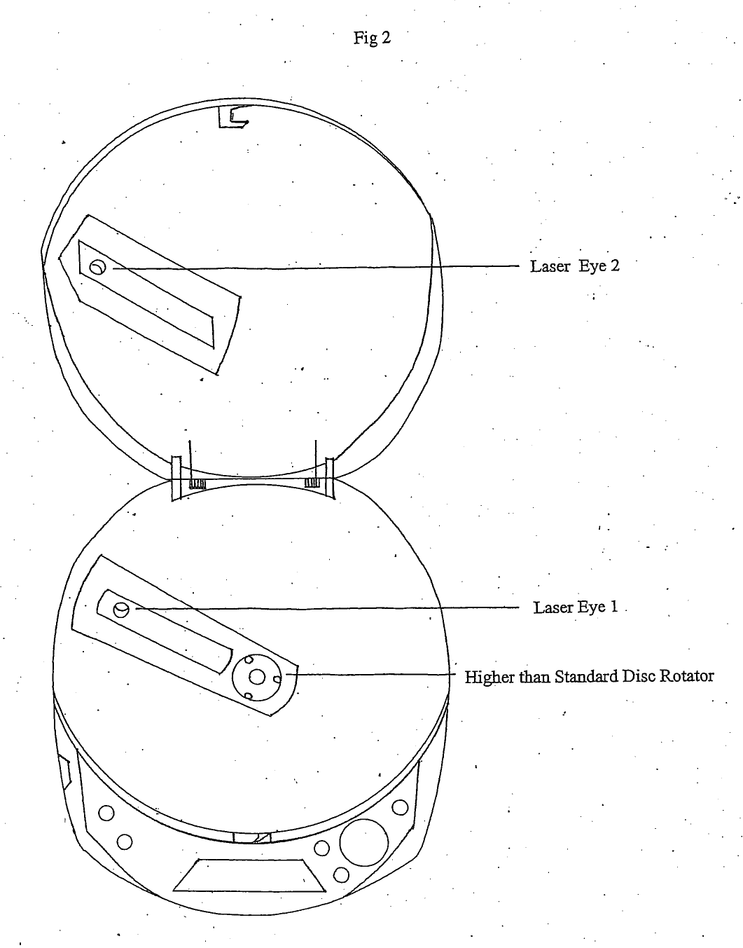

FIG. 3: illustrates how the two discs will be placed into the dual disc player. When opened, the first disc is put onto the rotator in a normal fashion with information to be read face down. The additional disc is then put onto the same disc rotator with the information to be read facing upward to the second laser eye. The compact disc player is then closed with both discs enclosed inside the dual disc structure.

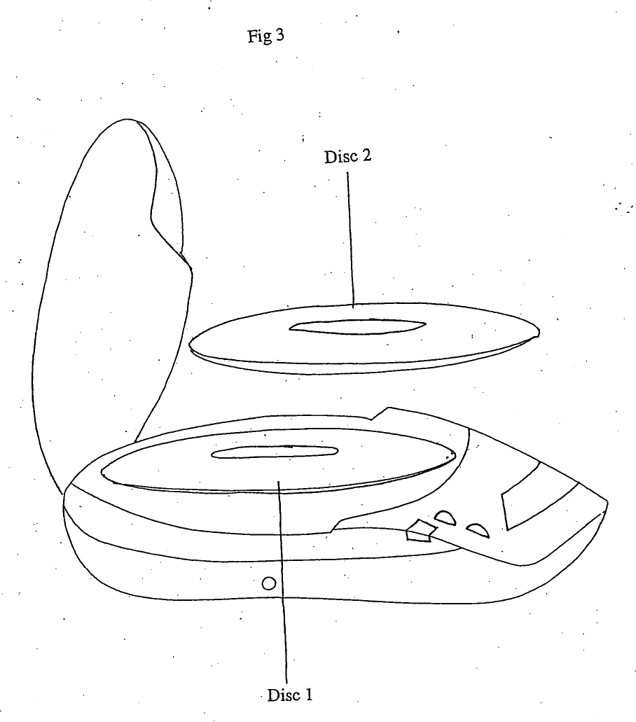

FIG. 4: shows the side view of my invention units closed form. This angle is used to show the clearance needed to install an additional laser eye into a normal portable compact disc player. The angle of description illustrates the added height to the portion with the added laser eye. The visual aid to my preferred setup is not to limited in exterior design but is needed in one form or another to ensure proper function in its utility.

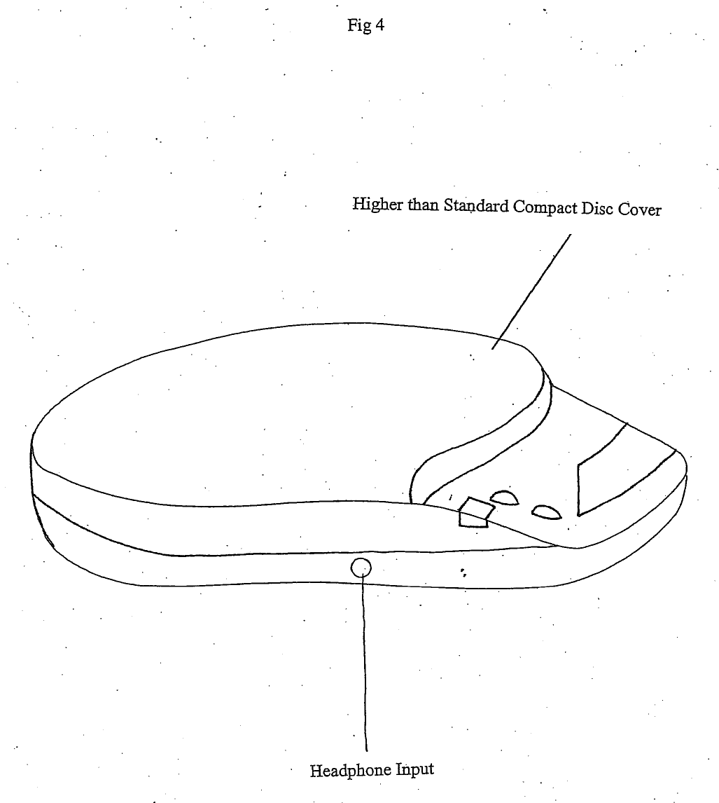

FIG. 5: depicts the control device located along the headphone cord. The control unit is placed midway between the headphones and headphones plug. Configured on the unit are major buttons used to operate the hold buttons and other play, pause, or skip options.

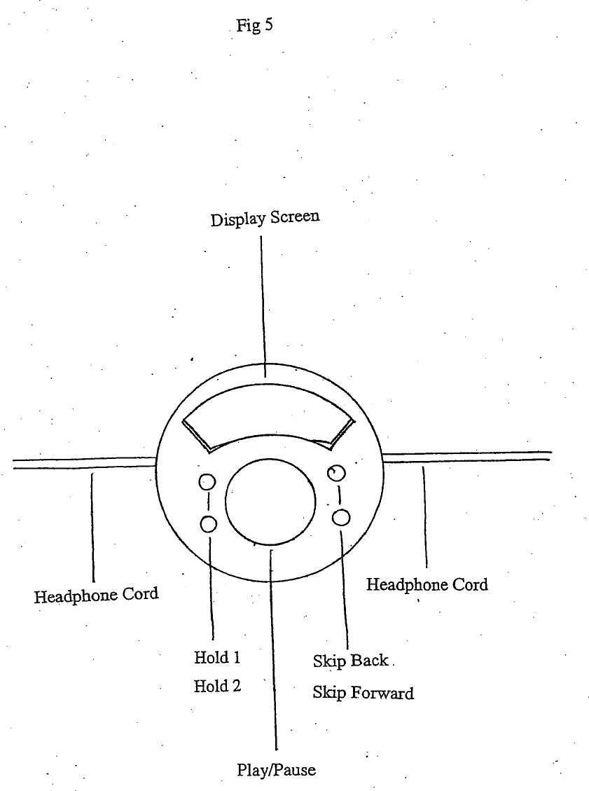

### DETAILED DESCRIPTION OF THE PREFERRED EMBODIMENT

Reference will now be made to the embodiments of the invention with at least one example of which is illustrated in the drawings. It should be appreciated that the embodiments are provided by way or explanation or the invention, and not meant as a limitation of the invention.

According to my invention, I have provided a portable compact disc player that is capable of holding and playing two compact discs instead of the normal single disc player. The compact disc player is conventional in appearance when in its unopened form. The portable compact disc player, when opened, reveals an additional laser eye disc reader integrated in the roof of the conventional portable disc player. Too allow the additional disc, the disc rotator is made slightly longer to hold two discs.

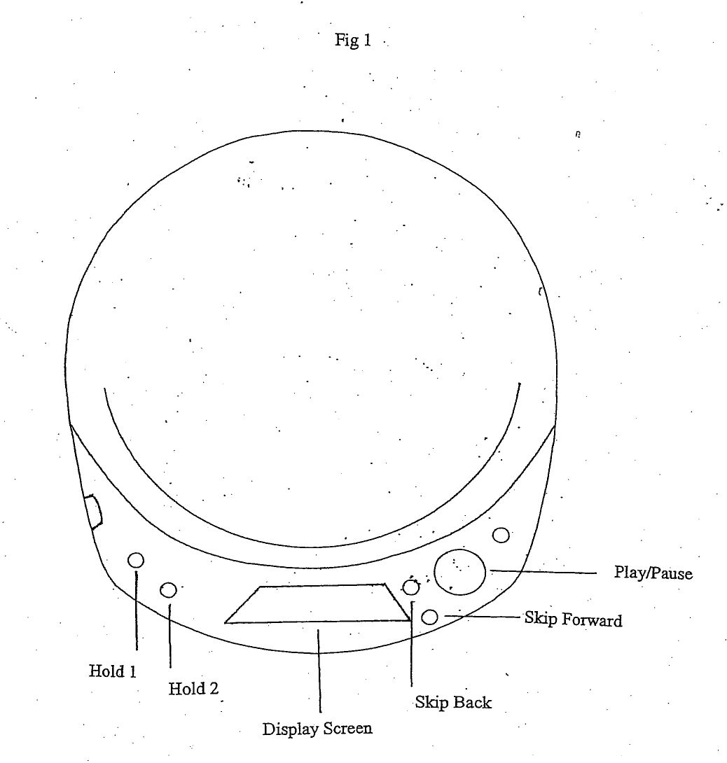

My dual disc configuration is traditional in structure design being that it opens and closes in a conventional fashion, but is not limited in exterior design as shown in description FIG. 1. To listen to the first disc the user would press down the number two hold button, by doing so the additional laser eye inside the roof of the player will be disabled allowing only the first laser eye to read disc number one. At this time all command functions will only be applied to the disc that is being listening to. If the user would like to listen to the second disc he or she would press first the stop button, followed by the number one hold button and then press play. The sequence order of these commands would first stop both the laser eye reader and engage the second laser eye reader. The play command would then begin the disc rotator and play what is being read by the second laser eye. Being that both discs are stacked onto the same disc rotator, during the command play both disc will spin regardless of which disc is being listened to. The power supply needed to power my invention would use two of the type batteries used in today's standard compact disc player, known as double AA. The power usage for my invention would not exceed that of two double A's batteries. During all time of function of my invention only one laser eye would be working at a time, while both discs are being spun by one motor; therefore no additional batteries are required to operate my invention.

My dual disc structure will utilize MP3 compatible laser eye reader. With the use of these unique laser eyes my invention will be able to read MP3 compact disc that were personally made by the user of my invention. MP3 disc are able to hold up to 60 songs on one disc. The user would simple download his or her favorite compilation of songs from their personal computer onto MP3 discs, allowing them to listen to nearly three times the normal amount of music in a personal compact disc player with the use of my invention. When opened, the user of the dual disc structure will a compact disc onto the disc rotator with the information to be read facing down toward the laser eye disc reader. The second disc is then placed onto the same disc rotator with the information to be read facing upward toward the inside roof of the portable disc player. Doing so will allow the second laser eye to read the second disc.

After the insertion of the discs, the dual disc player is closed in the normal fashion. At this time the user can now choose the disc he or she would like to listen to. The disc that is being read by the laser eye on the bottom of the compact disc player is known as the first disc. The additional disc placed on top of the first disc is known as the second disc.

To make my invention more user friendly it would come packaged with a special of headphones that have a control unit located in between the headphones and headphones plug. This control unit will allow the user to have access to the hold buttons and other important control functions. This control would promote the user to listen to their while participating in such activities ranging from cardio workouts to lifting weights.

What is claimed is:

1. A portable dual compact disc player structure, comprising:
A CD player that opens and closes in the traditional way of today's CD player, that when opened reveals an additional laser eye integrated inside the compact disc players roof. This device has the same function buttons as the standards compact disc player; in addition has two hold buttons.

2. The portable dual compact disc player configuration as in claim 1, where in said opened revealed extra laser eye when opened also exposes slightly longer CD holder. This enables the use of two compact disc or the device known as MP3 disc.

3. A portable dual compact disc player as in claim 1, traditional in structure in unopened position has two hold buttons that are unique in its function and utility. The above said hold buttons, unique in function and allows user to play desired disc while the other is on hold. Only one laser eye reads information from desired disc.

4. This invention is unique in its ability to play two MP3 discs consecutively without opening disc player and changing disc; as a result to 120 songs may be played from the two disc played inside. In anticipation of advanced technology, my invention will be the first to play double sided compact disc, without having to remove and reinsert disc CD player. This function is allowed by the use of hold buttons as stated in claim 3.

5. Portable dual disc player is MP3 compatible and enable users to play personal CDs that are capable of holding more information than 80 minute standard compact discs used today.

6. A device that is connected to the telephone cord which stems from the compact disc player and has all the function buttons as stated in claim one.
